(19) United States
(12) Patent Application Publication
(10) Pub. No.: US 2015/0195637 A1
(43) Pub. Date: Jul. 9, 2015

(54) Ultra-lightweight and portable combination boom pole and stand

(71) Applicant: Jeffrey Pawlan, San Jose, CA (US)

(72) Inventor: Jeffrey Pawlan, San Jose, CA (US)

(21) Appl. No.: 14/120,518

(22) Filed: May 28, 2014

Related U.S. Application Data
(60) Provisional application No. 61/964,515, filed on Jan. 3, 2014.

(51) Int. Cl. H04R 1/08; F16M 11/22; F16M 11/28

(52) U.S. Cl. CPC H04R 1/08; F16M 11/28; F16M 11/22

(57) ABSTRACT

A multipurpose stand vertical pole configured to support at least one boom-pole. A base is configured to couple to the vertical pole making a vertical stand of the combination, the base and the vertical pole being separable and configured to be decoupled during storage or transportation.

The base comprises a plurality of receptacles, radially integrated into the base. Each receptacle is configured to accept, hold, or engage a corresponding arm. Each corresponding arm is configured to extend from the base, approximately parallel to a floor or supporting surface. Each arm has an associated and coupled support pad or foot. Each support pad or foot is configured to contact the floor or supporting surface, providing support of each corresponding arm and each support pad or foot is approximately the same thickness or dimension as the distance between the bottom of each arm and the floor or supporting surface.

### PRIORITY CLAIM of PROVISIONAL APPLICATION

A claim for priority is hereby made under the provisions of 35 U.S.C. sctn.119 for the present non-provisional patent application based upon U.S. Provisional Patent Application No. 61/964,515 filed Jan. 3, 2014, entitled “Ultra-Lightweight and Portable Combination Boom Pole and Stand,” the entirety of which is hereby incorporated by reference for all that is taught and disclosed therein.

### FIELD of the INVENTION

The present invention relates generally to a microphone stand as a combination of a lightweight boom-pole and an ultra-lightweight stand that is easily transportable in airline luggage or a backpack and quickly set up.

### BACKGROUND

Traditionally a microphone stand is comprised of tubular column that is heavy plus a base that frequently contains cast iron, water, or sand to keep it stable by its weight. The other established alternative is a large collapsible tripod that is stable owing to its large size and locking mechanism. Music instrument stands, especially for keyboards, typically have a large four leg structure. Traditionally, cameras are mounted on tripods which are stable owing to the heavy weight and large area formed by the three legs which are necessarily wide spaced for stability.

U.S. Pat. No. 672,705 to Halladay in 1901 shows a folding stand that one of the original folding tripods with a locking mechanism.

U.S. Pat. No. 1,006,427 to Boraks in 1911 shows a folding tripod sheet music stand that is the most common in use today.

U.S. Pat. No. 1,570,216 to Garret and Rogers in 1926 shows an improved folding tripod music stand that is also still in use today.

U.S. Pat. No. 1,837,637 to Walberg shows a collapsible locking system for the tripod legs of a drum stand. This is frequently used today on collapsible microphone stands.

U.S. Pat. No. 3,173,642 to Greenspan shows a folding music instrument stand comprised of three heavy and long legs coupled to a disk at the base of the column. When deployed, it occupies too much floor surface area to be modified for a microphone stand for most sound recording applications.

U.S. Pat. No. 3,573,401 to Lininger shows a desktop microphone stand. This utilizes a heavy large area base.

U.S. Pat. No. 4,671,479 to Johnson, et al shows a three legged stand that is in common use today. The legs are large and heavy and are fastened to a base member that must be heavy to hold the legs and column in a sturdy fashion. It also occupies too much surface area for many sound recording applications.

U.S. Pat. No. 4,718,624 to Greulich shows a folding microphone stand. This relies on a large diameter heavy base casting to provide stability. Although it is portable in an automobile trunk, it is far too heavy and large for carrying in a suitcase, backpack, or bag by hand.

U.S. Pat. No. 4,744,536 to Bancalari shows a collapsible pole and stand combination that is specific for administration of medications intravenously to a patient in home care. The legs pivot on the base and fold upwards.

U.S. Pat. No. 5,497,965 to Mathieu shows a releasable microphone stand apparatus. This relies on a heavy metal base for support.

U.S. Pat. No. 5,509,629 to Sassmannshausen shows a musical instrument stand with three braced legs as a tripod.

U.S. Pat. No. 5,833,199 to Benting shows a sheet music or orator's stand that is made lighter in weight by utilizing synthetic resin materials. However, it relies on heavy metal weights placed in the base to provide stability and lower the center of gravity.

U.S. Pat. No.5,893,541 to Michaelson is for a microphone stand. It relies on a heavy metal base for support.

U.S. Pat. No. 6,283,421 B1 to Eason et al shows an instrument support system. This utilizes a tripod.

U.S. Pat. No. 6,375,135 B1 to Eason et al shows another tripod.

U.S. Pat. No. 6,491,266 B1 to Chen shows a camera or microphone stand with legs that rotate around the column.

U.S. Pat. No. 6,609,686 B2 to Malizia shows an adjustable stand that also relies on a conventional heavy metal base for support.

U.S. Pat. No. 6,663,060 to Gifford, Sr. shows a microphone stand that also relies on a conventional heavy metal base for support.

U.S. Pat. No. 6,666,427 to Hennessey shows a stand base having a modified hexagonal configuration. His description includes the several drawbacks of the usual heavy cast metal round base including stability and interference with the feet of the performer. Nevertheless, his base is either heavy case metal or filled with sand or water for weight.

U.S. Pat. No. 6,695,268 B1 to Hseih shows an adjustable footprint stand that folds to a small size but requires heavy construction materials to provides rigidity. When assembled, it occupies too much surface area for many sound recording applications so it is more useful as a sheet music holder.

U.S. Pat. No. 8,345,911 B2 to Fulks shows a combination stand that has a base that is described as typically heavy, hexagonal in shape, and is either bolted to the floor or sitting on wheels, ball bearings or coasters.

Unfortunately, there are no microphone stand products that are designed to accommodate a passenger during regular airline or airport travel. Neither of the above-mentioned patents nor prior art describe a microphone stand that is lightweight, small and portable enough for said air travel.

### SUMMARY OF THE INVENTION

This invention relates to a microphone stand having a collapsible or telescoping vertical pole or column which may also be used with a small camera or a small light for illumination. The stand is comprised of a separable stand base and support column that might also be utilized as a handheld boom pole.

The stand base is ultra-lightweight and comprised of a disk plus removable stabilizing extensions or feet. The base is unique as it does not rely on either weight or on traditional tripod legs to provide stability to the stand. Instead, a plurality of removable ultra-lightweight arms are placed radially and parallel to the floor or supporting surface in receptacle holes within the circumference of the very light and small base. These arms are held in place by thumbscrews or other means, such as spring clips, and their distal ends have coupled foam pads to provide stability. The number of arms is ideally five. However, a range of three or more arms may be used. There is a diminishing return of stability improvement when the number of arms exceeds seven. The arms can be of various suitable lengths to accommodate the height of the support column and the expected overturning or tipping force that might be applied to the stand in the specific use circumstance. Very short arms only a few inches long can be utilized when the height of the column is lower and there is little chance of an overturning force. The arms can be fashioned longer for use when the support column is fully extended or there is probability that a performer might accidentally hit the stand.

The stand base is small in diameter, lightweight, and may be fashioned from clear Lucite plastic or other materials in a first embodiment. One feature of reduced size and lightweight designs is the advantage that it can be placed within airline luggage, even carry-on, without being any threat to security.

The vertical support device in the first embodiment is a multisection carbon fiber monopod. The support end of the monopod comprises a custom metal fitting that holds a protruding ⅜″-16 thread from it which is then used to attach to a user supplied microphone holder or an adapter for a camera. The large end of the monopod is utilized to screw into a threaded insert in the center of the base.

### BRIEF DESCRIPTION OF THE DRAWINGS

FIG. 1a is a top view of a base showing radially bored holes, thumbscrews, and a threaded insert to hold a telescoping column.

FIGS. 1b and 1c are top views of alternate shapes that can be used for the base.

FIG. 2 is a cross-sectional side view of the base in FIG. 1 showing radially bored holes, thumbscrews, and a threaded insert configured to couple to a telescoping column.

FIG. 3 is a side cut view of the end piece for a stand column.

FIG. 4 is a side view of one of the arms showing a coupled pad.

FIG. 5 is an oblique view of the bottom of an assembled stand. A base shows a plurality of arms in place and a column is coupled to the base.

FIG. 6 is a side view of a base with arms in place and a column coupled to the base.

FIG. 7 is a side view of the top of the telescoping column showing the support end with a mounting adapter holding a protruding thread.

FIG. 8 is an oblique view of the assembled stand. The base has arms coupled in place and a column is coupled to the base. A telescoping column is shown in its fully collapsed position.

FIG. 9 is an oblique view of an assembled stand coupled to a telesoping column. The base has arms coupled in place and a column coupled to the base. The entire telescoping column is shown in its fully extended position. Lengths of arms shown are for illustrative purposes and do not indicate a specific ratio between the length of a column and lengths of arms.

FIG. 10a is a side view of the end of an alternative arm design.

FIG. 10b is a top view of the end of an alternative arm design.

FIG. 10c is a side view of the alternative arm design shown attached to the base

### DETAILED DESCRIPTION

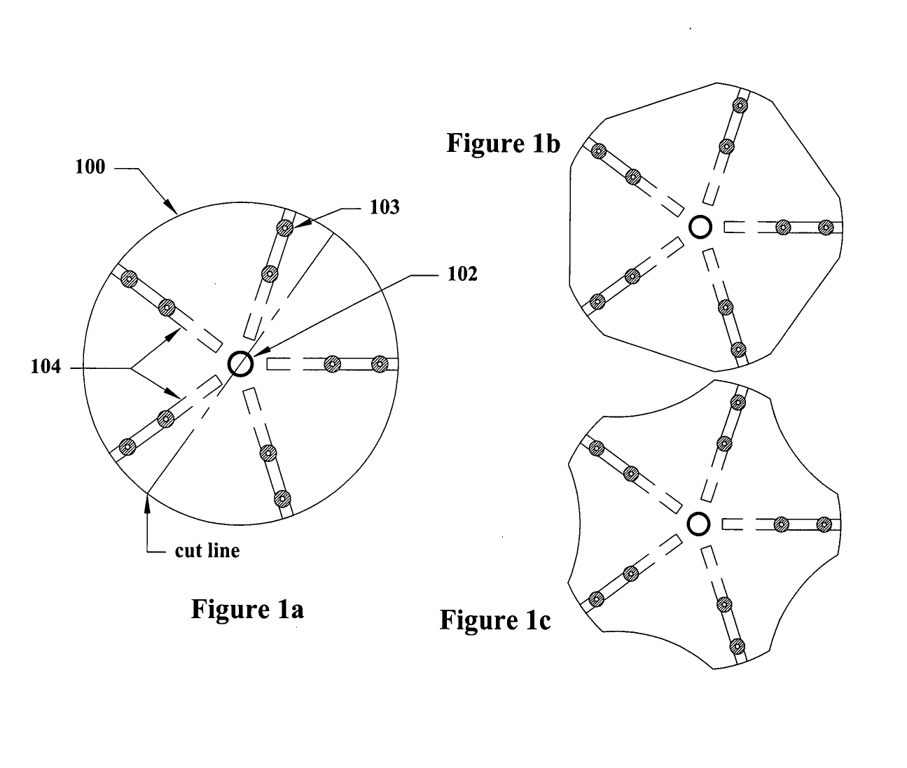

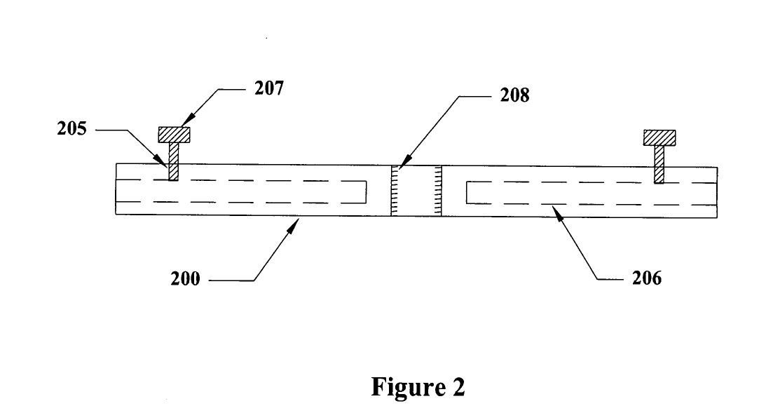

FIG. 1 a shows a top view of a stand base 100. FIG. 2 shows a side cross-sectional view of the stand base 200. In a first embodiment, the stand base 100, 200 may be a round (shown in FIG. 1a) or a polygon shape (shown in FIG. 1b and FIG. 1c) having a plurality of equal or unequal sides. The stand base 100, 200 is made of a lightweight material such as a clear acrylic, Lucite, polycarbonate, resin, plastic, or other material. In an embodiment of the stand base using Lucite, the material is strong, easy to machine, light weight, and clear, transparent or translucent, which makes it easier to pass airline security inspections. In addition, plastics, especially Lucite, is radiolucent so it may not show up when x-rayed or scanned.

The center of the stand base may be fitted with a threaded metal insert 102, 208 having an inside thread of ⅜″-16 which is a modern standard for microphone holders and camera adapters. The stand base constructed for the first embodiment is six inches in diameter. This size is not fixed and might be larger or smaller as desired in manufacture. In alternative embodiments, the stand base diameter dimension may range from approximately three inches to twenty inches, depending on specific requirements, providing a preferred balance or compromise between weight and stability.

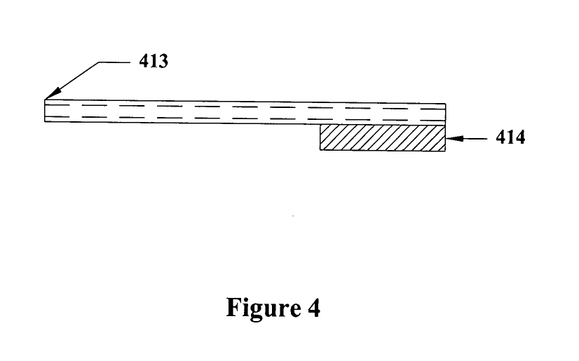

Through the circumference or polygonal points of the stand base at approximately the midline height level are a plurality of radially bored holes, or receptacles, 104, 206 configured to accept or couple to a single arm 413, 513, 613, 805 (as shown in FIGS. 4, 5, 6, and 8) for each receptacle. FIGS. 1a-c and FIG. 2 show five receptacles, although a range of three to seven receptacles and corresponding arms may be used. Each receptacle and corresponding arm is configured to be approximately parallel to the floor or surface that the microphone stand base rests upon.

In the first embodiment, there are two drilled and tapped holes 103, 205 associated with each receptacle and corresponding arm. The drilled and tapped holes are arranged or configured through the top of the stand base intersecting into the radial bored holes associated with each of the arms. The drilled and tapped holes are configured to accept thumbscrews 103, 207, 503, 603, 802 which, when tightened, contact and hold each inserted arm 413, 513, 613, 805 into place as shown in FIGS. 4, 5, 6, and 8. For example, #4 thumbscrews, 5/16″ diameter knurl style knob on 4-40×⅜″ stainless screws may be used to tighten and couple the base arms into with the base stand. This particular thumbscrew size, shape and material are not specific or required for this invention.

The base stand thickness is sufficient to provide sufficient mechanical stiffness to support a support column and to provide a sufficient strength and thread depth for the drilled and tapped holes. In the first embodiment, the stand base is approximately 0.5 inches thick. However, in alternative embodiments, a stand base thickness may range from 0.25 to several inches to accommodate alternative designs and requirements. In another alternative embodiment, spring clips are used in place of the drilled and tapped holes and thumbscrews. In an additional embodiment, an arm configured as a square, rectangular or a strip is fastened or coupled to the body at the top of the base. In this additional embodiment, thumbscrews are inserted through each arm and screwed to drilled and tapped holes at the top of the base, providing the option of using a thinner stand base.

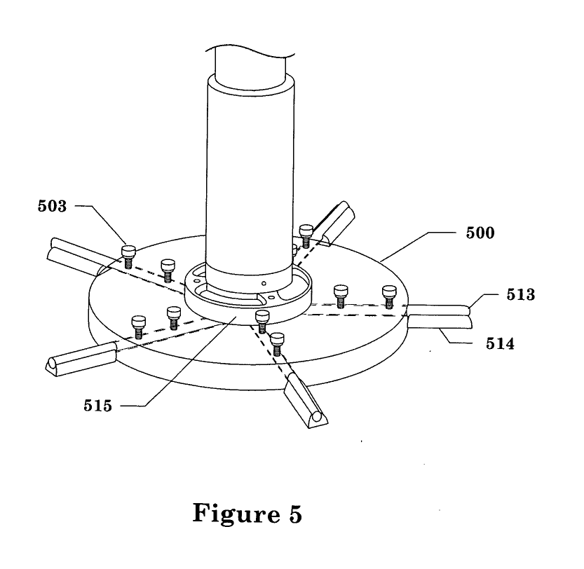

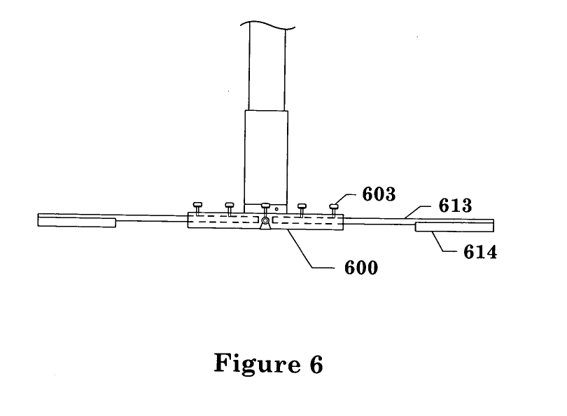

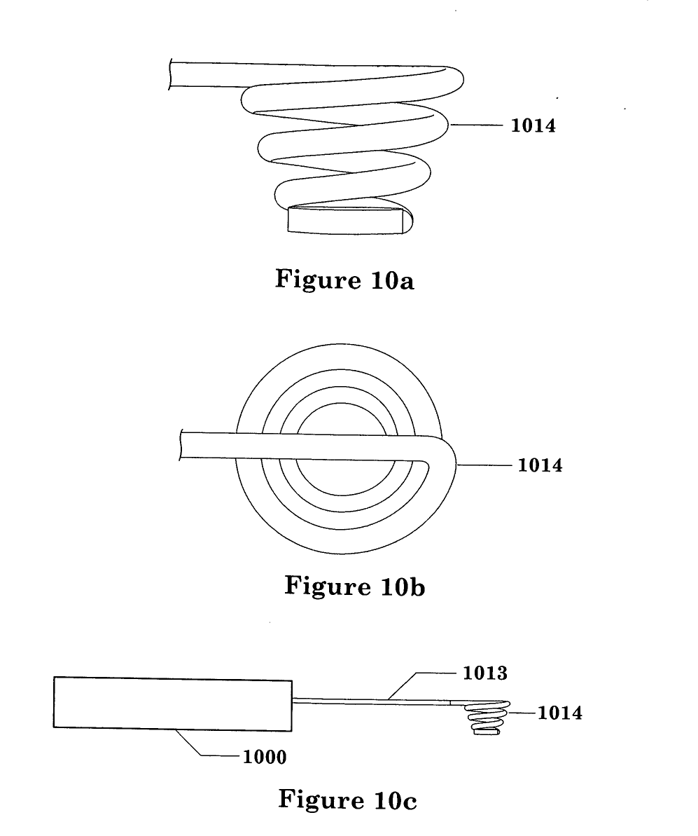

FIG. 4. shows the side view of an arm 413 for the first embodiment. Each arm may be constructed of carbon fiber tubing or may be constructed using materials such as plastics or resins, that provide equivalent strength and weight appropriate for the size of a microphone stand. These materials are chosen to be significantly lighter in weight than metal tubing or rod and may be generally stronger than either thin metal tubing or plastic rod. A pad 414 is coupled to the arm tubing. The pad may be made, for example, of foam rubber coupled to the arm. An exemplary component coupling the pad with the arm may be an adhesive or glue. Alternative coupling methods include but are not limited to insertion, snaps, and screws or other fasteners. The pad is approximately the same thickness as the distance between the bottom of the arm and the floor or supporting surface. The pad therefore does not lift the base off of the floor or supporting surface yet it provides support for the stand by making the apparent virtual diameter of the base larger than the physical stand base (as shown in FIG. 6, 600, 613, 614). FIG. 5 and FIG. 6 show the first embodiment of the base stand 100, 500, 600, arms 413, 513, 613, 805, pads 414, 514, 614, 806 and thumbscrews 103, 503, 603, 802. An alternative pad 1014 design is shown in FIG. 10a-c. This alternate pad design has a 3-dimensional spiral shape configured to be coupled with the end of each arm 1013 so it can act as a slightly springy support pad. A top view of the alternate pad design is shown in FIG. 10b and a side view of the alternate pad design is shown in FIG. 10a. Additional modifications to the base might include a non-slip pad coupled to the bottom of the base. The microphone stand may be further stabilized by taping or coupling each arm to the floor or a supporting surface.

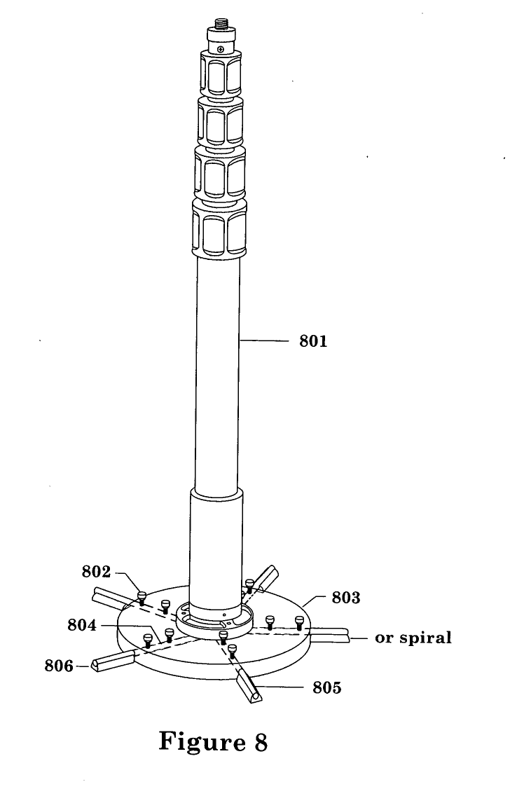

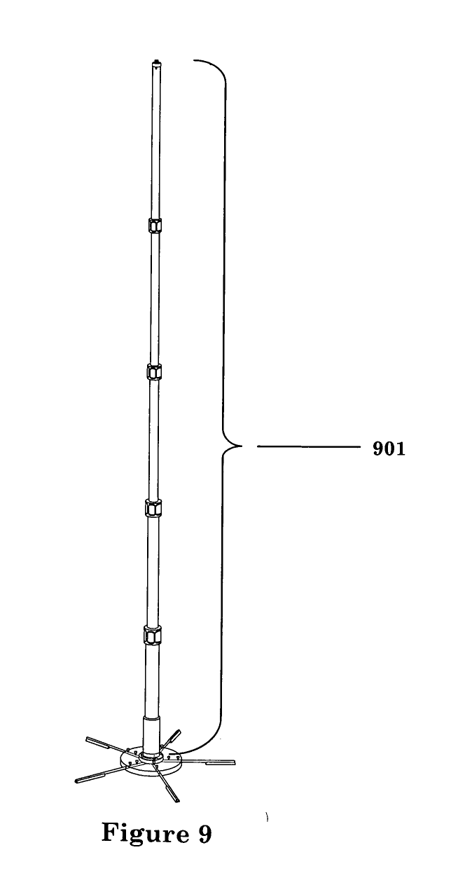

Referring to FIG. 8 and FIG. 9, the telescoping vertical support column or monopod 801, 901 in the first embodiment comprises five sections of carbon fiber, inter-coupled tubes having a large length range, 68 inches to 19 inches between its extended length and its closed length yet it is very lightweight and strong. Alternative materials include aluminum, aluminum-magnesium alloy or other lightweight materials. Preferred dimensions are approximately within 68 inches fully extended and configured to collapse down to approximately 19 inches. A specifically designed column could be made that has six sections so that it could close down to a shorter height.

FIG. 5 shows the original top platform end of the monopod 515 used to fasten to the base.

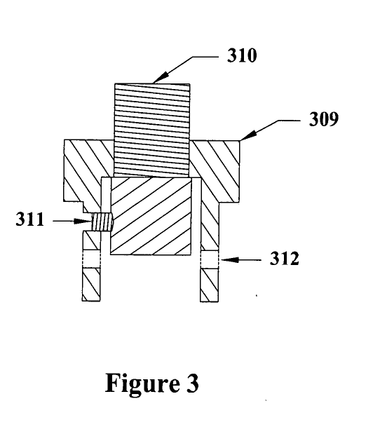

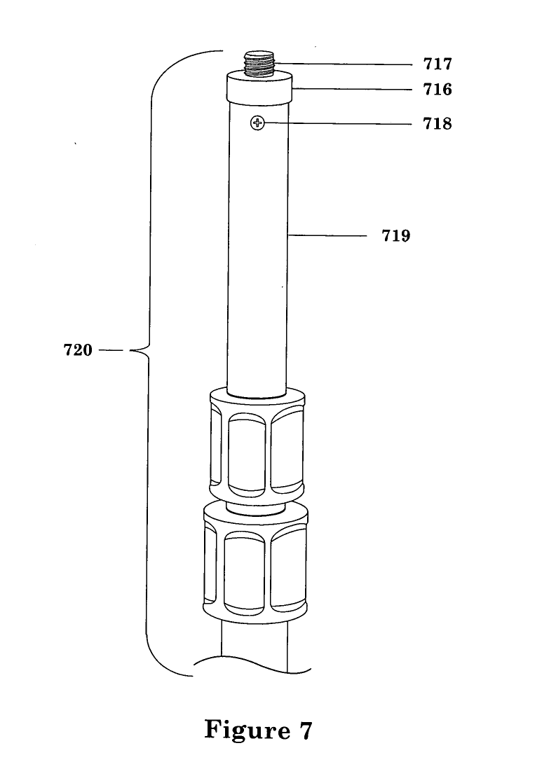

FIG. 7 shows one end 719 of the monopod 720 coupled to a custom machined metal mounting adaptor 716 which is configured to slide into the end of a last monopod carbon fiber tube. The mounting adaptor is held in place with screws or other equivalent stabilizing fasteners. In the first embodiment, the mounting adaptor is custom machined with a protruding ⅜″-16 thread 717. One of two screws 718 hold the mounting adaptor securely in the end of the last carbon fiber monopod tube. A cross-sectional view of the mounting adaptor is shown in FIG. 3. The mounting adaptor comprises a ⅜″-16 machine screw 310 that protrudes vertically upward and configured so that a microphone or camera can be affixed to the monopod. In other embodiments, the mounting adaptor could be manufactured of plastic or carbon fiber. The body of the mounting adaptor is shown as 309. A threaded hole through the wall of the mounting adaptor holds a set screw 311 which prevents the ⅜″-16 screw from loosening and turning. Two threaded holes 312 through the wall of the metal piece accept the machine screws which hold the metal piece securely in the end of the telescoping column.

The stand base and monopod are separate and are configured to be decoupled during storage or transportation. The telescoping column might be used as a boom-pole by attaching a microphone or camera to the threaded screw protruding from the mounting adaptor. It is then usual and customary practice for an operator to hold one or more boom-poles with his hands and arms. If the user wants to use this invention as a stationary vertical stand, then the large end of the column is screwed into the threaded insert in the center of the base.

While the invention has been described in terms of specific embodiments, those of ordinary skill in the art will recognize that the invention is not limited to the embodiments described, but can be practiced with modification and alteration within the spirit and scope of the appended claims. The description is thus to be regarded as illustrative instead of limiting.

1. A multipurpose stand, configured to support at least one boom-pole, the multipurpose stand comprising:
a vertical pole; and
a base configured to couple to the vertical pole making a vertical stand of the combination, the base and the vertical pole being separable and configured to be decoupled during storage or transportation; and
a plurality of receptacles, radially integrated into the base, each receptacle configured to accept, hold, or engage a corresponding arm, each corresponding arm being configured to extend from the base, approximately parallel to a floor or supporting surface; and
a plurality of support pads or feet, each pad or foot associated with and coupled to a corresponding arm; and
each support pad or foot configured to contact the floor or supporting surface, providing support of each corresponding arm; and
each support pad or foot having approximately the same thickness or dimension as the distance between the bottom of each arm and the floor or supporting surface.

2. The device of claim 1 wherein the base is comprised of a radiolucent material

3. The device of claim 1 wherein the base comprises a clear acrylic, or Lucite, or a polycarbonate, or a resin, or a plastic, or aluminum, or magnesium-aluminum material.

4. The base of claim 1 further including a supportive base pad coupled to the bottom surface of the base, the base pad configured to increase the stability and anchoring of the base.

5. The device of claim 1 further including at least one hole associated with each corresponding receptacle, each hole being vertically arranged and extending from the top of the base and intersecting with each corresponding receptacle.

6. The device of claim 5 wherein each hole associated with a corresponding receptacle is configured to hold, or engage a clamp or spring device, the base further including the clamp or spring device to facilitate coupling, or holding, or gripping an arm within each corresponding receptacle.

7. The device of claim 5 wherein each hole associated with a corresponding receptacle is drilled and tapped to accept or engage at least one corresponding thumbscrew, the base further including at least one corresponding thumbscrew which, when tightened, contacts each corresponding arm and facilitates the clamping, or holding, or gripping of each corresponding arm within each corresponding receptacle.

8. The device of claim 1 wherein the arms are made of rods or tubing with foam pads coupled to their distal ends.

9. The device of claim 1 wherein the arms are made of rods or tubing with a 3-dimensional spiral shape spring coupled to their distal ends.

10. The device of claim 1 wherein five or more receptacles and corresponding arms are used.

11. The device of claim 1 wherein the vertical pole is a multi-section collapsible or telescoping pole.

12. The device of claim 1 wherein the vertical pole is a monopod single-section pole.

13. A multipurpose stand, configured to support at least one boom-pole, the multipurpose stand comprising:
a vertical pole; and
a base comprised of a radiolucent material, the base configured to couple to the vertical pole making a vertical stand of the combination, the base and the vertical pole being separable and configured to be decoupled during storage or transportation; and
a plurality of receptacles, radially integrated into the base, each receptacle configured to accept, hold, or engage a corresponding arm, each corresponding arm being configured to extend from the base, approximately parallel to a floor or supporting surface; and
at least one drilled and tapped hole associated with a corresponding receptacle, each hole being vertically arranged and extending from the top of the base and intersecting with each corresponding receptacle, each hole also configured to accept or engage a corresponding thumbscrew which, when tightened, contacts each corresponding arm and facilitates the clamping, or holding, or gripping, or coupling of each corresponding arm within each corresponding receptacle; and
a plurality of support pads or feet, each pad or foot associated with and coupled to a corresponding arm; and
each support pad or foot configured to contact the floor or supporting surface, providing support of each corresponding arm; and
each support pad or foot having approximately the same thickness or dimension as the distance between the bottom of each arm and the floor or supporting surface.

14. The device of claim 13 wherein the base comprises a clear acrylic, or Lucite, or a polycarbonate, or a resin, or a plastic material

15. The base of claim 13 further including a supportive base pad coupled to the bottom surface of the base, the base pad configured to increase the stability and anchoring of the base.

16. The device of claim 13 wherein the arms are made of rods or tubing with foam pads coupled to their distal ends.

17. The device of claim 13 wherein five or more receptacles and corresponding arms are used.

18. The device of claim 13 wherein the vertical pole is a multi-section collapsible or telescoping pole.

19. The device of claim 13 wherein the vertical pole is a monopod single-section pole.

20. A multipurpose stand, configured to support at least one boom-pole, the multipurpose stand comprising:
a vertical pole; and
a base comprised of a radiolucent material, the base configured to couple to the vertical pole making a vertical stand of the combination, the base and the vertical pole being separable and configured to be decoupled during storage or transportation; and
a plurality of receptacles, radially integrated into the base, each receptacle configured to accept, hold, or engage a corresponding arm, each corresponding arm being configured to extend from the base, approximately parallel to a floor or supporting surface; and
at least one hole associated with a corresponding receptacle, each hole being vertically arranged and extending from the top of the base and intersecting with each corresponding receptacle; and
a plurality of support pads or feet, each pad or foot associated with and coupled to a corresponding arm; and
each support pad or foot configured to contact the floor or supporting surface, providing support of each corresponding arm; and
each support pad or foot having approximately the same thickness or dimension as the distance between the bottom of each arm and the floor or supporting surface.

21. The device of claim 20 wherein the base comprises a clear acrylic, or Lucite, or a polycarbonate, or a resin, or a plastic material.

22. The base of claim 20 further including a supportive base pad coupled to the bottom surface of the base, the base pad configured to increase the stability and anchoring of the base.

23. The device of claim 20 wherein each hole associated with a corresponding receptacle is configured to hold, or engage a clamp or spring device, the base further including the clamp or spring device to facilitate coupling, or holding, or gripping an arm within each corresponding receptacle.

24. The device of claim 20 wherein each hole associated with a corresponding receptacle is drilled and tapped to accept or engage at least one corresponding thumbscrew, the base further including at least one corresponding thumbscrew which, when tightened, contacts each corresponding arm and facilitates the clamping, or holding, or gripping of each corresponding arm within each corresponding receptacle.

25. The device of claim 20 wherein five or more receptacles and corresponding arms are used.

26. The device of claim 20 wherein the arms are made of rods or tubing with a 3-dimensional spiral shape spring coupled to their distal ends.

27. The device of claim 20 wherein the vertical pole is a multi-section collapsible or telescoping pole.

28. The device of claim 20 wherein the vertical pole is a monopod single-section pole.
